(19) United States
(12) Patent Application Publication
(10) Pub. No.: US 2025/0166365 A1
(43) Pub. Date: May 22, 2025

(54) INFORMATION PROCESSING DEVICE, INFORMATION PROCESSING METHOD, AND NON-TRANSITORY COMPUTER READABLE STORAGE MEDIUM

(71) Applicant: SONY GROUP CORPORATION, TOKYO (JP)

(72) Inventors: YUTA TAKIDA, TOKYO (JP); MASAAKI IMAIZUMI, TOKYO (JP); TAKASHI SHIBUYA, TOKYO (JP); CHIEH-HSIN LAI, TOKYO (JP); TOSHIMITSU UESAKA, TOKYO (JP); NAOKI MURATA, TOKYO (JP); YUHKI MITSUFUJI, TOKYO (JP)

(21) Appl. No.: 18/811,049

(22) Filed: Aug. 21, 2024

Related U.S. Application Data
(60) Provisional application No. 63/600,761, filed on Nov. 20, 2023.

(30) Foreign Application Priority Data
Jan. 29, 2024 (JP) 2024-011331

(51) Int. Cl. G06V 10/82; G06V 10/771; G06V 10/774; G06V 10/776

(52) U.S. Cl. CPC G06V 10/82; G06V 10/771; G06V 10/774; G06V 10/776

(57) ABSTRACT

An information processing device according to the present application is an information processing device including a model generation unit that generates a generative adversarial network including a discriminator and a generator. The model generation unit separates the discriminator into a feature extraction network that generates, from data input to the discriminator, feature vectors of the data and a last layer in which the feature vectors distributed in a feature vector space are applied to a one-dimensional space, and trains each of the feature extraction network and the last layer, and thereby generates a metrizable discriminator that is a discriminator capable of evaluating a distance between a probability distribution of generated feature vectors that are feature vectors of generated data generated by the generator and a probability distribution of real feature vectors that are feature vectors of real data included in a data set for training.

### CROSS-REFERENCE TO RELATED APPLICATIONS

This application claims priority from U.S. Patent Application No. 63/600,761, filed on November 20 and Japanese Application No. 2024-011331, filed on Jan. 29, 2024, the contents of which are incorporated by reference herein in its entirety.

### BACKGROUND OF THE INVENTION

### 1. Field of the Invention

The present disclosure relates to an information processing device, an information processing method, and a non-transitory computer-readable storage medium having stored therein a program.

### 2. Description of the Related Art

Conventionally, techniques related to generative adversarial networks (GANs) have been known. The aim of a generative adversarial network is to learn a target probability distribution that data generated by a neural network, called a generator, is to follow. In order to achieve the aim, a neural network called a discriminator is introduced, and the generator and the discriminator are optimized by a minimax method.

Non-Patent Literature 1: Ian Goodfellow, Jean Pouget-Abadie, Mehdi Mirza, Bing Xu, David Warde-Farley, Sherjil Ozair, Aaron Courville, and Yoshua Bengio, “Generative adversarial nets”, Neural Information Processing Systems (NeurIPS), 2014/6, vol. 27, pp. 2672-2680.

However, in the conventional technique described above, data generated by a generator of a generative adversarial network is sometimes biased to a specific pattern, or the generator sometimes generates many sets of similar data (also referred to as mode collapse). In other words, in the conventional technique, the diversity of data generated by the generator of the generative adversarial network is limited in some cases.

In view of this, the present disclosure proposes an information processing device, an information processing method, and a program capable of enhancing the diversity of data generated by a generator of a generative adversarial network.

### SUMMARY OF THE INVENTION

It is an object of the present invention to at least partially solve the problems in the conventional technology.

According to one aspect of an embodiment, an information processing device according to the present application is an information processing device including a model generation unit that generates a generative adversarial network including a discriminator and a generator. The model generation unit separates the discriminator into a feature extraction network that generates, from data input to the discriminator, feature vectors of the data and a last layer in which the feature vectors distributed in a feature vector space are applied to a one-dimensional space, and trains each of the feature extraction network and the last layer, and thereby generates a metrizable discriminator that is a discriminator capable of evaluating a distance between a probability distribution of generated feature vectors that are feature vectors of generated data generated by the generator and a probability distribution of real feature vectors that are feature vectors of real data included in a data set for training.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explanation of a generative adversarial network according to a conventional technique;

FIG. 2 is a diagram for explanation of a generative adversarial network according to a conventional technique;

FIG. 3 is a diagram for explanation of a difference between a generative adversarial network according to a conventional technique and a generative adversarial network according to an embodiment of the present disclosure;

FIG. 4 is a diagram illustrating an example of the configuration of an information processing device according to an embodiment of the present disclosure;

FIG. 5 is a diagram for explanation of a generative adversarial network according to an embodiment of the present disclosure;

FIG. 6 is a diagram for explanation of a generative adversarial network according to an embodiment of the present disclosure;

FIG. 7 is a diagram for explanation of three conditions to be satisfied by a metrizable discriminator according to an embodiment of the present disclosure; and

FIG. 8 is a hardware configuration diagram illustrating an example of a computer that implements the functions of an information processing device according to the present disclosure.

### DETAILED DESCRIPTION OF THE PREFERRED EMBODIMENTS

Hereinafter, embodiments of the present disclosure are described in detail with reference to the drawings. In the following embodiments, the same parts are denoted by the same reference numerals and redundant description is omitted.

### EMBODIMENT

### 1. Introduction

In an embodiment of the present disclosure, a case where a generative adversarial network generates image data will be described. The generative adversarial network according to the embodiment of the present disclosure is not limited to one that generates image data, and may be one that generates data other than image data, such as text data or audio data. Further, the generative adversarial network according to the embodiment of the present disclosure is not limited to the original GAN published in the article “Generative Adversarial Nets” by Ian Goodfellow et al., in 2014, and may be various derivative GANs such as deep convolutional GAN (DCGAN), CycleGAN, and StyleGAN.

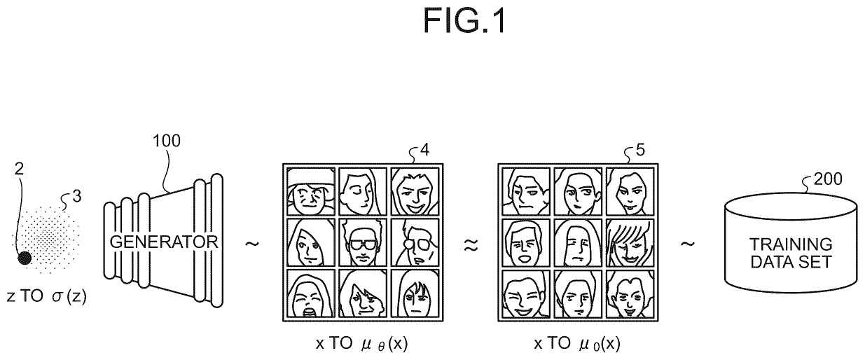

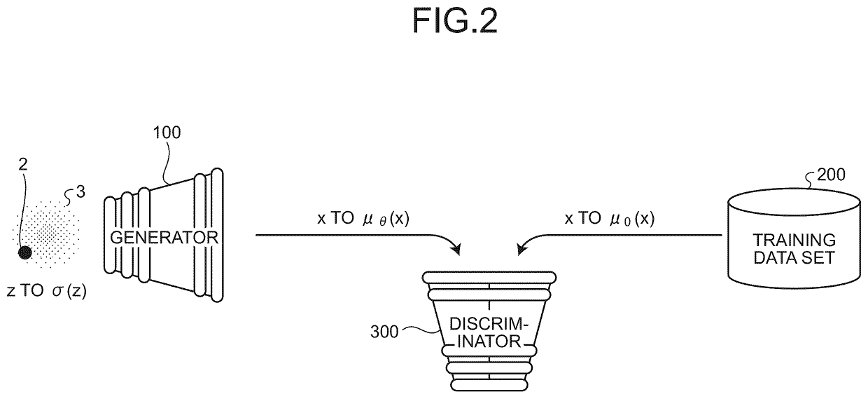

Generally, a generative adversarial network is a machine learning model that generates pseudo-data similar to actual data given as training data (hereinafter, referred to as “real data” in some cases). Specifically, the generative adversarial network has two neural networks called a generator and a discriminator. The generative adversarial network is created through training the generator and the discriminator to compete with each other (through adversarial learning). Training the generator and the discriminator to compete with each other as described above corresponds to solving a minimax problem of a loss function common to the generator and the discriminator. The following specifically describes a learning method of a generative adversarial network according to a conventional technique with reference to FIGS. 1 and 2.

FIG. 1 is a diagram for explanation of the generative adversarial network according to the conventional technique. In FIG. 1, a generator 100 of the generative adversarial network generates image data 4 on persons from random noise 2 sampled from a normal distribution 3 (which may be a uniform distribution). FIG. 1 illustrates image data on nine different persons generated by the generator 100. FIG. 1 also illustrates image data on nine different persons as image data 5 included in a training data set 200. In practice, the generator 100 learns the features of a large amount of image data, for example 100,000.

In FIG. 1, the generator 100 assumes that the image data 5 included in the training data set 200 is generated based on a given probability distribution. Hereinafter, the probability distribution from which the image data 5 included in the training data set 200 is generated is referred to as a target probability distribution μ₀. That is, the generator 100 assumes that the image data 5 included in the training data set 200 is data sampled from the target probability distribution μ₀. In other words, when the image data 5 included in the training data set 200 is represented by a variable x, the generator 100 assumes that x follows a target probability distribution function μ₀(x).

The generator 100 also assumes that image data 4 generated by the generator 100 itself is also generated based on a given probability distribution. Hereinafter, the probability distribution from which the image data 4 generated by the generator 100 is generated is referred to as a model probability distribution μ_{θ}. That is, the generator 100 assumes that the image data 4 generated by the generator 100 itself is data sampled from the model probability distribution μ_{θ}. In other words, when the image data 4 generated by the generator 100 itself is represented by a variable x, the generator 100 assumes that x follows a model probability distribution function μ_{θ}(x).

Further, the generator 100 learns so that the model probability distribution μ_{θ} is bought close to the target probability distribution μ_{θ}. In other words, the generator 100 tries to learn so that the distance between the model probability distribution μ_{θ} and the target probability distribution μ₀ is as short as possible. As a result of the learning so as to reduce the distance between the model probability distribution μ_{θ} and the target probability distribution μ_{θ}, the generator 100 acquires the model probability distribution μ₀ close to the target probability distribution μ_{θ}. In addition, the generator 100 becomes able to generate the image data 4 based on the acquired model probability distribution μ_{θ}. Here, since the model probability distribution μ_{θ} acquired by the generator 100 is similar to the target probability distribution μ_{θ}, image data sampled from the model probability distribution μ₀ is similar to image data sampled from the target probability distribution μ_{θ}. That is, the generator 100 can generate the image data 4 similar to the image data 5 included in the training data set 200 by generating the image data 4 based on the acquired model probability distribution μ_{θ}.

FIG. 2 is a diagram for explanation of the generative adversarial network according to the conventional technique. First, a learning method of a discriminator 300 in the generative adversarial network will be described. The discriminator 300 is trained to distinguish whether data input to the discriminator 300 itself is authentic data (hereinafter, referred to as “real data” in some cases) or fake data generated by the generator 100 of the generative adversarial network. The discriminator 300 is trained in a state where the value of a parameter of the generator 100 is fixed. Specifically, the generator 100 generates image data from random vectors. The discriminator 300 is trained to, in a case where image data generated by the generator 100 (hereinafter, referred to as “generated data” in some cases) is input, output “0” that is a value indicating that the generated data is fake data. In addition, the training data set 200 includes a large number of sets of real data. The discriminator 300 is trained to, in a case where the real data included in the training data set 200 is input, output “1” that is a value indicating that the real data is authentic data.

More specifically, the discriminator 300 calculates the value of a loss function of the GAN based on an output result of the discriminator 300 itself (“scalar output value”), and updates the value of the parameter of the discriminator 300 using the error backpropagation method. Here, the value of the loss function of the GAN takes a large value in a case where the discriminator 300 determines that the real data is authentic data (case where the output value is close to “1”), and takes a small value in a case where the discriminator 300 determines that the real data is fake data (case where the output value is close to “0”). Further, the value of the loss function of the GAN takes a small value in a case where the discriminator 300 determines that the generated data is authentic data (case where the output value is close to “1”), and takes a large value in a case where the discriminator 300 determines that the generated data is fake data (case where the output value is close to “0”). The discriminator 300 learns the values of the parameter of the discriminator 300 so as to maximize the value of the loss function of the GAN. In this manner, the discriminator 300 is trained to distinguish whether the data input to the discriminator 300 itself is authentic data (real data) or fake data (generated data). In other words, the discriminator 300 is trained to distinguish whether the data input to the discriminator 300 itself is data sampled from the target probability distribution μ₀ (real data) or data sampled from the model probability distribution μ_{θ} (generated data). That is, it can be interpreted that the discriminator 300 according to the conventional technique serves to evaluate the distance between the model probability distribution μ_{θ} and the target probability distribution μ_{θ}.

Next, a learning method of the generator 100 will be described. The generator 100 is trained to generate such data that the discriminator 300 identifies as authentic data. The generator 100 is trained in a state where the value of a parameter of the discriminator 300 is fixed. Specifically, the generator 100 generates image data (generated data) from random vectors. The ideal discriminator 300 receives the generated data as an input value, and outputs “1” in a case where it is determined that the generated data is authentic data (real data), and outputs “0” in a case where it is determined that the generated data is fake data. The generator 100 is trained to generate such data that the output result of the discriminator 300 is “1”.

More specifically, the generator 100 calculates the value of a loss function of the GAN based on an output result of the discriminator 300 (“scalar output value”), and updates the value of the parameter of the generator 100 using the error backpropagation method. Here, the value of the loss function of the GAN takes a small value in a case where the discriminator 300 determines that the generated data is authentic data (case where the output value is close to “1”), and takes a large value in a case where the discriminator 300 determines that the generated data is fake data (case where the output value is close to “0”). The generator 100 learns the values of the parameter of the generator 100 so as to minimize the value of the loss function of the GAN. In this way, the generator 100 is trained to generate such generated data that the discriminator 300 identifies as authentic data. In other words, the generator 100 learns the model probability distribution μ_{θ} that generates such generated data that the discriminator 300 identifies as data sampled from the target probability distribution μ_{θ}. In other words, in order to bring the generated data sampled from the model probability distribution μ_{θ} close to the real data sampled from the target probability distribution μ_{θ}, the generator 100 learns so that the model probability distribution μ_{θ} is brought close to the target probability distribution μ₀. For example, the generator 100 uses an index D (for example, Jensen-Shannon (JS) divergence) for quantitatively evaluating the distance between the model probability distribution μ_{θ} and the target probability distribution μ_{θ}. The generator 100 is then trained to minimize the value of the index D based on the output result of the discriminator 300.

The learning method of the generative adversarial network according to the conventional technique can be expressed as a minimax problem represented by the following Formula (1). In the following Formula (1), a function corresponding to the generator 100 is denoted by θ, a function corresponding to the discriminator 300 is denoted by f, a loss function of the GAN when the generator 100 is trained is denoted by J_{GAN}, and a loss function of the GAN when the discriminator 300 is trained is denoted by V_{GAN}. The first half term of the following Formula (1) represents a minimization problem regarding the function θ. The second half term of the following Formula (1) represents a maximization problem regarding the function f. Note that the loss function J_{GAN} and the loss function V_{GAN} are common functions.

$${min}_{θ} {GAN}_{} ( θ ; f ) and {max}_{f ∈ ℱ ( X , ℝ )} {GAN}_{} ( f ; θ ) \qquad ( 1 )$$

In the first half term of the above Formula (1), the value of the parameter of the function θ that decreases the value of the loss function J_{GAN} is calculated after fixing the value of the parameter related to the function f. Further, in the second half term of the above Formula (1), the value of the parameter related to the function f that increases the value of the loss function V_{GAN} is calculated after fixing the value of the parameter of the function θ.

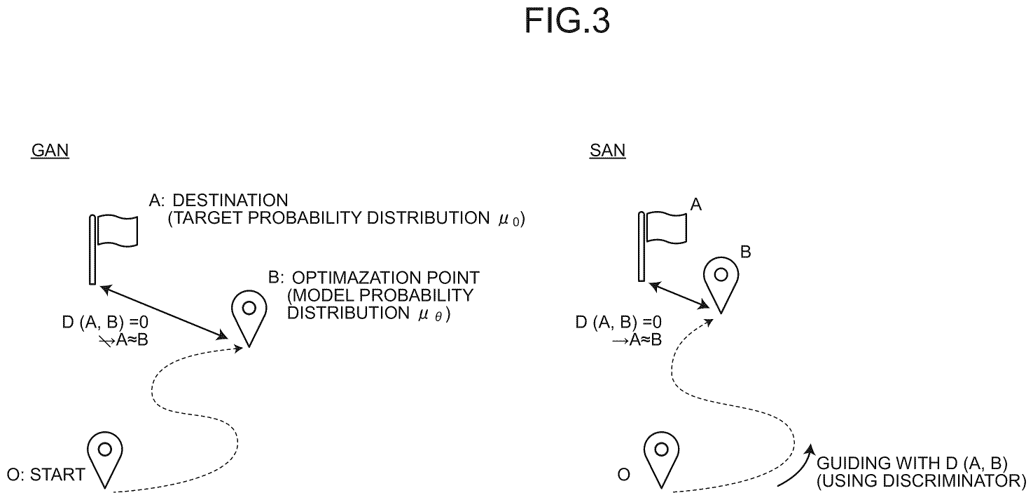

FIG. 3 is a diagram for explanation of a difference between the generative adversarial network according to the conventional technique and a generative adversarial network according to an embodiment of the present disclosure. The generative adversarial network according to an embodiment of the present disclosure is called a slicing adversarial network (SAN). For details on the SAN, see reference (Yuhta Takida, Masaaki Imaizumi, Takashi Shibuya, Chieh-Hsin Lai, Toshimitsu Uesaka, Naoki Murata, Yuki Mitsufuji, “SAN: Inducing Metrizability of GAN with Discriminative Normalized Linear Layer”, [online], Sep. 6, 2023, Internet <URL: https://arxiv.org/pdf/2301.12811v3.pdf>).

The left side of FIG. 3 illustrates a generative adversarial network (GAN) according to the conventional technique. As described with reference to FIGS. 1 and 2, the generator 100 according to the conventional technique is trained to minimize the value of the index D for evaluating the distance between the model probability distribution μ_{θ} and the target probability distribution μ₀ based on the output result of the discriminator 300. The left side of FIG. 3 illustrates a path from a probability distribution (start point O) of the generator 100 at the training start time point to the model probability distribution μ_{θ} (optimization point B) that is the optimized probability distribution through the training based on the output result of the discriminator 300. In addition, the left side of FIG. 3 illustrates that the discriminator 300 according to the conventional technique cannot appropriately evaluate the distance between the model probability distribution μ_{θ} and the target probability distribution μ_{θ}. Accordingly, a state is illustrated in which the distance between the target probability distribution μ₀ (destination A) targeted by the generator 100 and the model probability distribution μ_{θ} (optimization point B) is long. That is, the generator 100 according to the conventional technique cannot acquire the model probability distribution μ_{θ} close to the target probability distribution μ_{θ}. Note that, for details on the problems of the discriminator 300 and the generator 100 according to the conventional technique described with reference to the left side of FIG. 3, refer to the reference mentioned above.

As described with reference to the left side of FIG. 3, the discriminator 300 according to the conventional technique cannot appropriately evaluate the distance between the model probability distribution μ_{θ} and the target probability distribution μ_{θ}. In addition, since the generator 100 according to the conventional technique uses the discriminator 300 according to the conventional technique, making learning for reducing the distance between the model probability distribution μ_{θ} and the target probability distribution μ₀ a success is difficult. It is thus difficult to generate highly accurate data in the generative adversarial network according to the conventional technique. Specifically, in the generative adversarial network according to the conventional technique, data generated by the generator is sometimes biased to a specific pattern, or the generator sometimes generates many sets of similar data (also referred to as mode collapse). In other words, in the generative adversarial network according to the conventional technique, the diversity of the data generated by the generator is limited.

The right side of FIG. 3 illustrates the generative adversarial network (SAN, hereinafter sometimes referred to as a “slicing adversarial network”) according to an embodiment of the present disclosure. The right side of FIG. 3 illustrates that a discriminator according to the embodiment of the present disclosure (discriminator of the slicing adversarial network) can appropriately evaluate the distance between the model probability distribution μ_{θ} and the target probability distribution μ_{θ}. That is, the discriminator of the slicing adversarial network is a discriminator capable of evaluating the distance between the model probability distribution μ₀ and the target probability distribution μ_{θ}. More specifically, the discriminator of the slicing adversarial network is a discriminator capable of evaluating the distance between a probability distribution of generated feature vectors and a probability distribution of real feature vectors distributed in a feature vector space of the discriminator. Hereinafter, a discriminator capable of evaluating the distance between the model probability distribution μ_{θ} and the target probability distribution μ₀ based on the probability distribution of the generated feature vectors and the probability distribution of the real feature vectors distributed in the feature vector space of the discriminator may be referred to as a “metrizable discriminator”. Here, the probability distribution of the generated feature vectors of the metrizable discriminator can be theoretically regarded as the same as the model probability distribution μ_{θ} of the generator. Further, the probability distribution of the real feature vectors of the metrizable discriminator can be theoretically regarded as the same as the target probability distribution μ₀ of the generator. For the theoretical details, refer to the reference mentioned above.

As described above, the discriminator of the slicing adversarial network (namely, a metrizable discriminator) can evaluate the distance between the model probability distribution μ_{θ} and the target probability distribution μ₀ of the generator by evaluating the distance between the probability distribution of the generated feature vectors and the probability distribution of the real feature vectors distributed in the feature vector space of the discriminator. As a result, the generator according to the embodiment of the present disclosure (the generator of the slicing adversarial network) can evaluate the distance between the model probability distribution μ_{θ} and the target probability distribution μ₀ of the generator by using the metrizable discriminator. As described above, since the metrizable discriminator can evaluate the distance between the model probability distribution μ_{θ} and the target probability distribution μ₀ of the generator, the generator of the slicing adversarial network can learn so that the distance between the target probability distribution μ₀ (destination A) and the model probability distribution μ_{θ} (optimization point B) is reduced appropriately as compared with the generator 100 according to the conventional technique. That is, the generator of the slicing adversarial network can acquire the model probability distribution μ_{θ} close to the target probability distribution μ₀. It should be noted that for details on the discriminator and the generator of the slicing adversarial network described with reference to the right side of FIG. 3, refer to the reference mentioned above.

As described with reference to the right side of FIG. 3, the discriminator according to the embodiment of the present disclosure can appropriately evaluate the distance between the model probability distribution μ₀ and the target probability distribution μ_{θ}. In addition, since the generator according to the embodiment of the present disclosure uses the discriminator according to the embodiment of the present disclosure, it is possible to succeed in learning for reducing the distance between the model probability distribution μ_{θ} and the target probability distribution μ₀. Therefore, the generative adversarial network according to the embodiment of the present disclosure can generate more accurate data than the generative adversarial network according to the conventional technique. Specifically, in the generative adversarial network according to the embodiment of the present disclosure, it is possible to reduce a case where data generated by the generator is biased to a specific pattern, or a case where the generator generates many sets of similar data (also referred to as mode collapse). In other words, the generative adversarial network according to the embodiment of the present disclosure can enhance the diversity of the data generated by the generator. As for a comparison result between the image data generated by the generative adversarial network according to the conventional technique and the image data generated by the slicing adversarial network, refer to the reference mentioned above.

### 2. Configuration of Information Processing Device

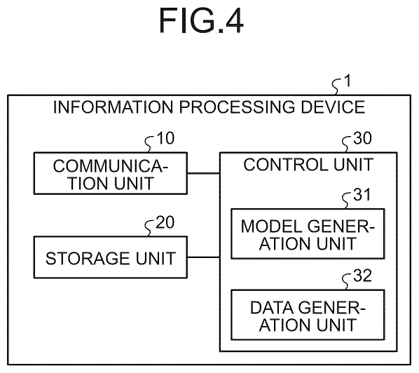

FIG. 4 is a diagram illustrating an example of the configuration of an information processing device according to an embodiment of the present disclosure. As illustrated in FIG. 4, an information processing device 1 includes a communication unit 10, a storage unit 20, and a control unit 30.

The communication unit 10 is implemented by, for example, a network interface card (NIC), or the like. The communication unit 10 is connected to a network wired or wirelessly, and may transmit and receive information to and from another information processing device.

The storage unit 20 is implemented by, for example, a semiconductor memory device such as a random access memory (RAN) or a flash memory, or a storage device such as a hard disk or an optical disk. For example, the storage unit 20 stores information regarding various programs (for example, a program according to the embodiment).

The control unit 30 is a controller, and is implemented by, for example, a central processing unit (CPU), a micro processing unit (MPU), an application specific integrated circuit (ASIC), a field programmable gate array (FPGA), or the like executing various programs stored in a storage device inside the information processing device 1 using a storage area such as the RAM as a work area. In the example illustrated in FIG. 4, the control unit 30 includes a model generation unit 31 and a data generation unit 32.

The model generation unit 31 generates a generative adversarial network including a discriminator and a generator. Specifically, the model generation unit 31 acquires a discriminator in the GAN (hereinafter, referred to as a “discriminator” in some cases). Subsequently, the model generation unit 31 separates the discriminator into a feature extraction network that generates, from data input to the discriminator, feature vectors of the data and the last layer in which the feature vectors distributed in the feature vector space are applied to a one-dimensional space, and trains each of the feature extraction network and the last layer, thereby generating a metrizable discriminator that is a discriminator capable of evaluating a distance between the probability distribution of the generated feature vectors that are feature vectors of generated data generated by the generator and the probability distribution of the real feature vectors that are feature vectors of real data included in a data set for training.

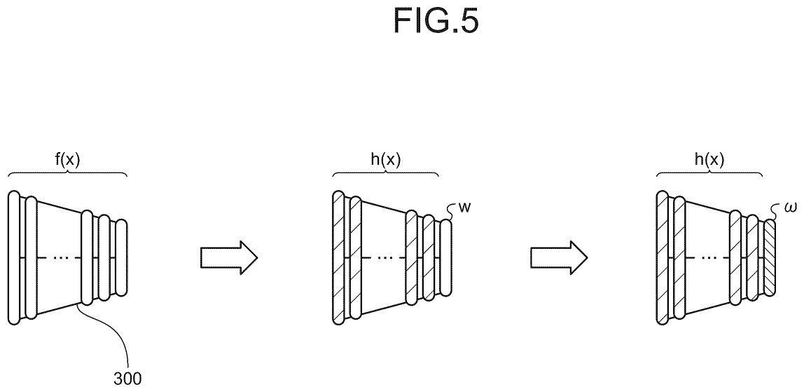

FIG. 5 is a diagram for explanation of the generative adversarial network according to the embodiment of the present disclosure. Hereinafter, the generative adversarial network according to the embodiment of the present disclosure is referred to as a slicing adversarial network (or SAN). In FIG. 5, the discriminator 300 according to the conventional technique includes a large number of layers. On the left side of FIG. 5, the discriminator 300 according to the conventional technique is indicated by a function f(x). x represents data (image data, for example) input to the discriminator 300. For example, x is generated data generated by the generator or real data included in a data set for training.

FIG. 5 illustrates, in the center thereof, a state in which the model generation unit 31 separates the network of the discriminator 300 into the feature extraction network that generates, from data input to the discriminator 300, feature vectors of the data and the last layer in which the feature vectors distributed in the feature vector space are applied to a one-dimensional space. Here, the feature extraction network is a network (or function) that generates, from the data (x) input to the discriminator 300, feature vectors of the data. In the center of FIG. 5, the feature extraction network is indicated by a function h(x). The feature extraction network includes a large number of layers other than the last layer of the discriminator 300. The last layer is a layer (or function) that converts the feature vectors generated by the feature extraction network into a scalar to apply the feature vectors to a one-dimensional space. Specifically, the last layer receives the feature vectors output from the feature extraction network as an input, and outputs a scalar numerical value. In the center of FIG. 5, the last layer is indicated by w. Specifically, the model generation unit 31 represents the function f(x) indicating the discriminator 300 in an inner product form of the function h(x) indicating the feature extraction network and w indicating the last layer. This is expressed in the following Formula (2).

$$f ( x ) = 〈 h ( x ) , w 〉 \qquad ( 2 )$$

Subsequently, the model generation unit 31 represents the function f(x) indicating the discriminator 300 in an inner product form of the function h(x) indicating the feature extraction network and ω obtained by normalizing w indicating the last layer with the norm of w. This is expressed in the following Formula (3).

$$f ( x ) = 〈 h ( x ) , ω 〉 \qquad ( 3 )$$

The model generation unit 31 separates the discriminator 300 into the feature extraction network and the last layer, and trains each of the feature extraction network and the last layer. More specifically, the model generation unit 31 separates the loss function of the discriminator 300 into the loss function of the feature extraction network and the loss function of the last layer to learn the value of the parameter of the feature extraction network and the value of the parameter of the last layer, thereby generating a metrizable discriminator. Specifically, the model generation unit 31 separates the loss function of the discriminator into the loss function of the feature extraction network and the loss function of the last layer to learn the value of the parameter of the feature extraction network and the value of the parameter of the last layer, thereby generating a metrizable discriminator.

Specifically, the learning method of the slicing adversarial network can be expressed as a minimax problem represented by the following Formula (4). The following Formula (4) corresponds to the above Formula (1). The model generation unit 31 learns each of the discriminator and the generator so as to optimize the minimax problem represented by the following Formula (4). In the following Formula (4), as in the above Formula (1), the function corresponding to the generator is indicated by θ, and the loss function of the generator is indicated by J_{GAN}. On the other hand, the following Formula (4) is different from the above Formula (1) in that the discriminator is represented in an inner product form of ω and h shown in the above Formula (3) In addition, the following Formula (4) is different from the above Formula (1) in that the loss function of the discriminator is separated into V^{h}_{SAN} that is a loss function of the feature extraction network and a loss function V^{ω}_{SAN} of the last layer. The first half term of the following Formula (4) represents a minimization problem regarding the function θ. The second half term of the following Formula (4) represents a maximization problem regarding each of the functions h and ω.

$${min}_{θ} {GAN}_{} ( θ ; 〈 ω , h 〉 ) and \qquad ( 4 )$$

$${max}_{ω ∈ {𝕊}^{D - 1} , h ∈ ℱ ( X , {ℝ}^{D} )} {SAN}_{h}^{} ( h ; ω , θ ) + {SAN}_{ω}^{} ( ω ; h , θ )$$

In the first half term of the above Formula (4), the model generation unit 31 learns the value of the parameter of the function θ that decreases the value of the loss function J_{GAN} after fixing the values of the parameters of the functions h and ω. Further, in the second half term of the above Formula (4), the model generation unit 31 learns the values of the parameters of the functions h and ω that increase the sum of the value of the loss function V^{h}_{SAN} and the value of the loss function V^{ω}_{SAN} after fixing the value of the parameter of the function θ. The term of the loss function V^{h}_{SAN} in the second half term of the above Formula (4) indicates that the model generation unit 31 learns the value of the parameter of the function h that decreases the value of the loss function V^{h}_{SAN} after fixing the values of the parameters of the functions θ and ω. Further, the term of the loss function V^{h}_{SAN} in the second half term of the above Formula (4) indicates that the model generation unit 31 learns the value of the parameter of the function ω that decreases the value of the loss function V^{ω}_{SAN} after fixing the values of the parameters of the functions θ and h.

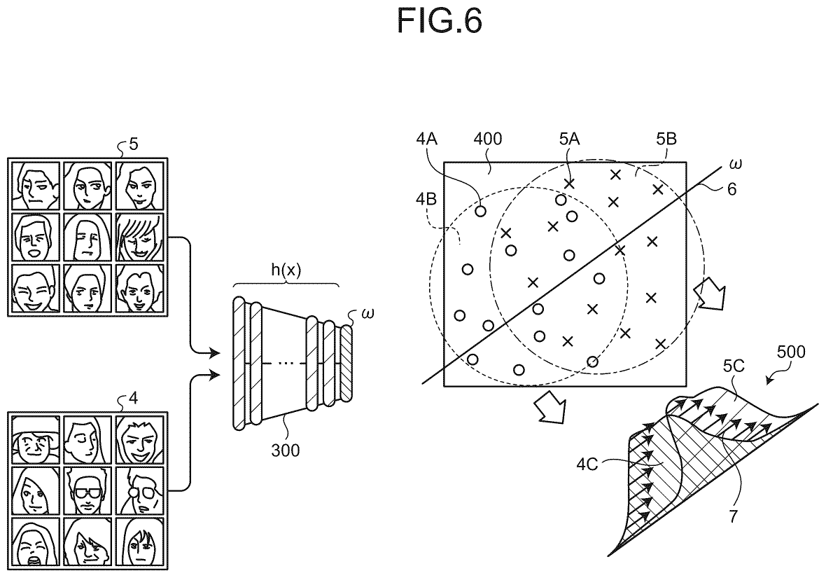

FIG. 6 is a diagram for explanation of the generative adversarial network according to the embodiment of the present disclosure. The feature extraction network (h) described with reference to FIG. 5 receives data (x) input to the discriminator as an input, and outputs feature vectors. That is, the feature extraction network (h) converts the data (x) input to the discriminator into feature vectors. The model generation unit 31 uses the feature extraction network (h) to generate, from the data (x) input to the discriminator, feature vectors of the data. In FIG. 6, the model generation unit 31 uses the feature extraction network (h) to generate real feature vectors 5A, which are feature vectors of the real data 5, from the real data 5 included in a data set for training. In addition, the model generation unit 31 uses the feature extraction network (h) to generate generated feature vectors 4A, which are feature vectors of the generated data 4, from the generated data 4 generated by the generator.

Further, in general, feature vectors generated using a feature extraction network are high-dimensional (for example, 100-dimensional or the like) vectors. That is, the feature extraction network (h) projects (maps) the data (x) input to the discriminator to a high-dimensional feature vector space. As a result, the feature vectors are distributed in the high-dimensional feature vector space. In FIG. 6, the model generation unit 31 uses the feature extraction network (h) to convert the real data 5 input to the discriminator into the real feature vectors 5A and maps the resultant to the feature vector space 400. As a result, the real feature vectors 5A are distributed in the feature vector space 400. In FIG. 6, the probability distribution of the real feature vectors 5A mapped to the feature vector space 400 by the model generation unit 31 is indicated by 5B. Further, the model generation unit 31 uses the feature extraction network (h) to convert the generated data 4 input to the discriminator into the generated feature vectors 4A and maps the resultant to the feature vector space 400. As a result, the generated feature vectors 4A are distributed in the feature vector space 400. In FIG. 6, the probability distribution of the generated feature vectors 4A mapped to the feature vector space 400 by the model generation unit 31 is indicated by 4B.

In addition, the last layer (ω) of the discriminator 300 applies the (high-dimensional) feature vectors distributed in the (generally high-dimensional) feature vector space to a one-dimensional space. In other words, the last layer projects (maps) the feature vectors to the one-dimensional space by converting the (generally high-dimensional) feature vectors into scalars. In FIG. 6, the model generation unit 31 uses the last layer (ω) to apply the real feature vectors 5A to the one-dimensional space 500. In other words, the model generation unit 31 uses the last layer (ω) to project (map) the real feature vectors 5A to the one-dimensional space 500 by converting the real feature vectors 5A into scalars. In this way, the model generation unit 31 uses the last layer (ω) to apply the probability distribution 5B of the real feature vectors 5A distributed in the feature vector space 400 to the one-dimensional space 500. In FIG. 6, the probability distribution of the real feature vectors 5A applied to the one-dimensional space 500 by the model generation unit 31 is indicated by 5C. Further, the model generation unit 31 uses the last layer (ω)) to apply the generated feature vectors 4A to the one-dimensional space 500. In other words, the model generation unit 31 uses the last layer (ω) to project (map) the generated feature vectors 4A to the one-dimensional space 500 by converting the generated feature vectors 4A into scalars. In this way, the model generation unit 31 uses the last layer (ω)) to apply the probability distribution 4B of the generated feature vectors 4A distributed in the feature vector space 400 to the one-dimensional space 500. In FIG. 6, the probability distribution of the generated feature vectors 4A applied to the one-dimensional space 500 by the model generation unit 31 is indicated by 4C.

Further, the parameter of the last layer (ω)) is a parameter related to a direction in the feature vector space 400. Specifically, the parameter of the last layer (ω) is a parameter related to a direction 6 in which the probability distribution 4B of the generated feature vectors and the probability distribution 5B of the real feature vectors distributed in the feature vector space 400 are separated. The model generation unit 31 trains the last layer (ω)) to take a value of a parameter corresponding to a direction in which the distance between the probability distribution 4B of the generated feature vectors and the probability distribution 5B of the real feature vectors is increased, thereby generating a metrizable discriminator.

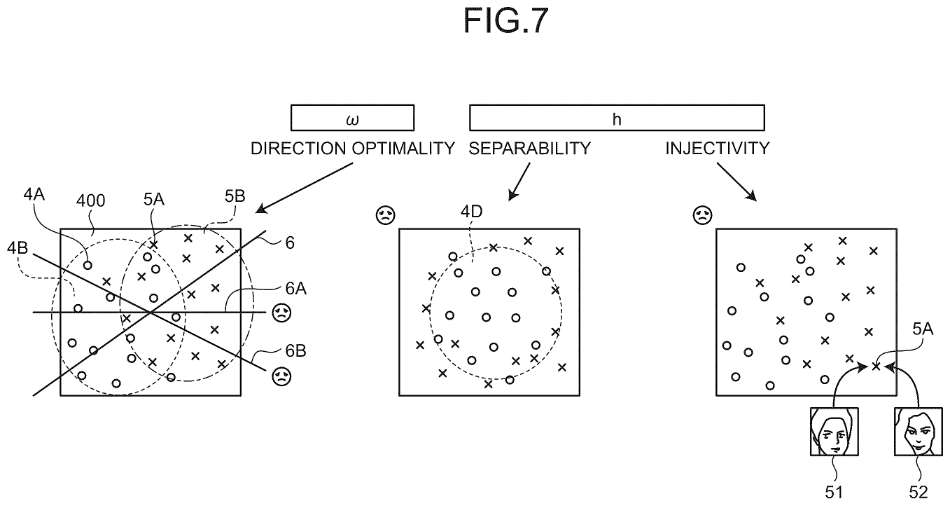

FIG. 7 is a diagram for explanation of three conditions to be satisfied by a metrizable discriminator according to the embodiment of the present disclosure. The model generation unit 31 trains the discriminator so as to satisfy the three conditions of direction optimality, separability, and injectivity to thereby generate a metrizable discriminator.

First, the direction optimality will be described. As illustrated on the left side of FIG. 7, the direction optimality means that the feature vector space 400 is sliced in the direction 6 in which the distance between the probability distribution 4B of the generated feature vectors 4A and the probability distribution 5B of the real feature vectors 5A distributed in the feature vector space 400 is increased as much as possible. For example, a direction 6A or 6B illustrated on the left side of FIG. 7 is not the direction 6 in which the distance between the probability distribution 4B of the generated feature vectors 4A and the probability distribution 5B of the real feature vectors 5A is increased as much as possible, and thus the direction optimality is not satisfied. In other words, the direction optimality refers to slicing the feature vector space 400 in the direction 6 in which the overlap between the probability distribution 4B of the generated feature vectors 4A and the probability distribution 5B of the real feature vectors 5A distributed in the feature vector space 400 is made as small as possible. That is, the fact that the discriminator satisfies the direction optimality corresponds to generating the last layer (ω)) that has learned the value of the parameter corresponding to the direction 6 in which the distance between the probability distribution 4B of the generated feature vectors 4A and the probability distribution 5B of the real feature vectors 5A distributed in the feature vector space 400 is increased. In other words, the fact that the discriminator satisfies the direction optimality corresponds to generating the last layer (ω)) that has learned the value of the parameter corresponding to the direction 6 in which the overlap between the probability distribution 4B of the generated feature vectors 4A and the probability distribution 5B of the real feature vectors 5A distributed in the feature vector space 400 is reduced.

The model generation unit 31 trains the discriminator so as to satisfy the direction optimality to thereby generate a metrizable discriminator. Specifically, the parameter of the last layer is a parameter related to a direction in which the probability distribution of the generated feature vectors and the probability distribution of the real feature vectors distributed in the feature vector space are separated. The model generation unit 31 trains the last layer to take a value of a parameter corresponding to a direction in which the distance between the probability distribution of the generated feature vectors and the probability distribution of the real feature vectors is increased, thereby generating a metrizable discriminator. In other words, the model generation unit 31 trains the last layer so as to realize conversion into the one-dimensional space 500 in which the overlap between the probability distribution of the generated feature vectors and the probability distribution of the real feature vectors distributed in the feature vector space is reduced, thereby generating a metrizable discriminator. More specifically, the model generation unit 31 trains, in a case where the generated feature vectors and the real feature vectors are input, the last layer so as to match a direction vector indicating a direction of the average vector of the real feature vectors viewed from the average vector of the generated feature vectors, thereby generating a metrizable discriminator.

Next, separability will be described. As illustrated on the right side of FIG. 6, the separability means that the probability distribution 4B of the generated feature vectors 4A and the probability distribution 5B of the real feature vectors 5A distributed in the feature vector space 400 are distributed so as to be separable. In other words, the separability means that if the probability distribution 4B of the generated feature vectors 4A is moved in a specific direction, the probability distribution 4B of the generated feature vectors 4A and the probability distribution 5B of the real feature vectors 5A overlap each other. For example, as an example satisfying the separability, a lower right part of FIG. 6 illustrates a state in which, when the probability distribution 4C of the generated feature vectors 4A applied to the one-dimensional space 500 by the model generation unit 31 is moved in a specific direction 7, the probability distribution 4C of the generated feature vectors 4A and the probability distribution 5C of the real feature vectors 5A overlap each other. For example, in the example illustrated in the center of FIG. 7, the real feature vectors 5A are distributed so as to surround the probability distribution 4D of the generated feature vectors 4A, and thus, even if the probability distribution 4B of the generated feature vectors 4A is moved in a specific direction, the probability distribution 4B of the generated feature vectors 4A and the probability distribution 5B of the real feature vectors 5A do not overlap each other. Therefore, the separability is not satisfied.

In other words, the fact that the discriminator satisfies the separability corresponds to training the feature extraction network (h) so as to generate a distribution in which if the probability distribution 4B of the generated feature vectors 4A is moved in a specific direction, the probability distribution 4B of the generated feature vectors 4A and the probability distribution 5B of the real feature vectors 5A overlap each other. The model generation unit 31 trains the discriminator so as to satisfy the separability to thereby generate a metrizable discriminator. Specifically, the model generation unit 31 trains the feature extraction network so that if the probability distribution of the generated feature vectors is moved in a specific direction, the probability distribution of the generated feature vectors and the probability distribution of the real feature vectors overlap each other, thereby generating a metrizable discriminator. More specifically, the model generation unit 31 trains the feature extraction network as follows: in a case where the generated data and the real data are input, the feature extraction network outputs the probability distribution of the generated feature vectors and the probability distribution of the real feature vectors such that the probability distribution of the generated feature vectors and the probability distribution of the real feature vectors overlap each other if the probability distribution of the generated feature vectors is moved in a specific direction. Thereby, the model generation unit 31 generates a metrizable discriminator.

Finally, the injectivity will be described. The injectivity indicates that the data input to the feature extraction network (h) and the feature vectors distributed in the feature vector space 400 have a one-to-one correspondence. In other words, the injectivity corresponds to the presence of the inverse function (h⁻¹) of the function h indicating the feature extraction network. The right side of FIG. 7 does not satisfy the injectivity because two different sets of real data 51 and 52 correspond to one real feature vector 5A. The model generation unit 31 trains the discriminator so as to satisfy the injectivity to thereby generate a metrizable discriminator. Specifically, the model generation unit 31 trains the feature extraction network such that the data and the feature vectors have a one-to-one correspondence, thereby generating a metrizable discriminator. More specifically, the model generation unit 31 trains, in a case where data is input, the feature extraction network to output a feature vector having a one-to-one correspondence to the data, thereby generating a metrizable discriminator.

As a result of the above training, the metrizable discriminator generated by the model generation unit 31 satisfies the three conditions of direction optimality, separability, and injectivity. At this time, as illustrated in the lower right of FIG. 6, the metrizable discriminator can evaluate the distance between the probability distribution of the generated feature vectors and the probability distribution of the real feature vectors applied to a one-dimensional space by the one-dimensional distance.

Further, the model generation unit 31 acquires a generator in the GAN (hereinafter, referred to as a “generator” in some cases). Subsequently, the model generation unit 31 uses the metrizable discriminator to generate a generator trained to reduce the distance between the probability distribution of the generated feature vectors and the probability distribution of the real feature vectors. Specifically, the model generation unit 31 trains the generator to reduce the distance between the probability distribution of the generated feature vectors generated by using the metrizable discriminator and the probability distribution of the real feature vectors. Here, the probability distribution of the generated feature vectors corresponds to the model probability distribution μ_{θ} described with reference to FIGS. 1 to 3. The probability distribution of the real feature vectors corresponds to the target probability distribution μ₀ described with reference to FIGS. 1 to 3. Specifically, the model generation unit 31 trains the generator to output image data (generated data) in a case where random vectors are input. More specifically, the model generation unit 31 trains the generator so as to generate data such that the output result of the metrizable discriminator is “1”. As a result, as illustrated on the right side of FIG. 3, the information processing device 1 can shorten the distance between the model probability distribution μ_{θ} (optimization point B) and the target probability distribution μ₀ (destination A). That is, in the information processing device 1, the generator can acquire the model probability distribution μ_{θ} close to the target probability distribution μ₀.

For details regarding the loss function used for training the discriminator and the generator by the model generation unit 31, refer to the reference mentioned above.

The data generation unit 32 uses the generator generated by the model generation unit 31 to generate generated data from random vectors. Specifically, in a case where random vectors are input, the model generation unit 31 outputs image data (generated data).

### 3. Effects

As described above, the information processing device 1 according to the embodiment of the present disclosure includes the model generation unit 31. The model generation unit 31 generates a generative adversarial network including a discriminator and a generator. The model generation unit 31 separates the discriminator into the feature extraction network that generates, from data input to the discriminator, feature vectors of the data and the last layer in which the feature vectors distributed in the feature vector space are applied to a one-dimensional space, and trains each of the feature extraction network and the last layer, thereby generating a metrizable discriminator that is a discriminator capable of evaluating a distance between the probability distribution of generated feature vectors that are feature vectors of generated data generated by the generator and the probability distribution of real feature vectors that are feature vectors of real data included in a data set for training.

As described above, the information processing device 1 generates a metrizable discriminator that is a discriminator capable of evaluating a distance between the probability distribution of generated feature vectors that are feature vectors of generated data generated by the generator and the probability distribution of real feature vectors that are feature vectors of real data included in a data set for training. As described above, the probability distribution of the generated feature vectors of the metrizable discriminator can be theoretically regarded as the model probability distribution μ_{θ} of the generator. Further, the probability distribution of the real feature vectors of the metrizable discriminator can be theoretically regarded as the target probability distribution μ₀ of the generator. This allows the information processing device 1 to appropriately evaluate the distance between the model probability distribution μ_{θ} and the target probability distribution μ₀ of the generator using the metrizable discriminator. Further, since the information processing device 1 can appropriately evaluate the distance between the model probability distribution μ_{θ} and the target probability distribution μ₀ of the generator, the generator can acquire the model probability distribution μ_{θ} close to the target probability distribution μ_{θ}. The information processing device 1 can therefore enhance the diversity of data generated by the generator of the generative adversarial network.

Further, the parameter of the last layer is a parameter related to a direction in which the probability distribution of the generated feature vectors and the probability distribution of the real feature vectors distributed in the feature vector space are separated. The model generation unit 31 trains the last layer to take a value of a parameter corresponding to a direction in which the distance between the probability distribution of the generated feature vectors and the probability distribution of the real feature vectors is increased, thereby generating a metrizable discriminator.

As a result, the information processing device 1 can generate a metrizable discriminator that satisfies the direction optimality.

Further, the model generation unit 31 trains the feature extraction network so that if the probability distribution of the generated feature vectors is moved in a specific direction, the probability distribution of the generated feature vectors and the probability distribution of the real feature vectors overlap each other, thereby generating a metrizable discriminator.

As a result, the information processing device 1 can generate a metrizable discriminator that satisfies the separability.

Further, the model generation unit 31 trains the feature extraction network such that the data and the feature vectors have a one-to-one correspondence, thereby generating a metrizable discriminator.

As a result, the information processing device 1 can generate a metrizable discriminator that satisfies the injectivity.

In addition, the model generation unit 31 separates the loss function of the discriminator into the loss function of the feature extraction network and the loss function of the last layer to learn the value of the parameter of the feature extraction network and the value of the parameter of the last layer, thereby generating a metrizable discriminator.

As a result, the information processing device 1 can separate the feature extraction network from the last layer to train each of the feature extraction network and the last layer. Therefore, the information processing device 1 can train the last layer so as to satisfy the direction optimality, and can train the feature extraction network so as to satisfy the separability and the injectivity.

Further, the model generation unit 31 uses the metrizable discriminator to generate a generator trained to reduce the distance between the probability distribution of the generated feature vectors and the probability distribution of the real feature vectors.

As a result, since the information processing device 1 can use the metrizable discriminator to appropriately evaluate the distance between the model probability distribution μ_{θ} and the target probability distribution μ₀ of the generator, the generator can acquire the model probability distribution μ_{θ} close to the target probability distribution μ₀.

The information processing device 1 further includes the data generation unit 32. The data generation unit 32 uses the generator generated by the model generation unit 31 to generate generated data from random vectors.

As a result, the information processing device 1 can generate the generated data using the generator that has acquired the model probability distribution μ_{θ} close to the target probability distribution μ₀, which makes it possible to enhance the diversity of the data generated by the generator.

### 4. Hardware Configuration

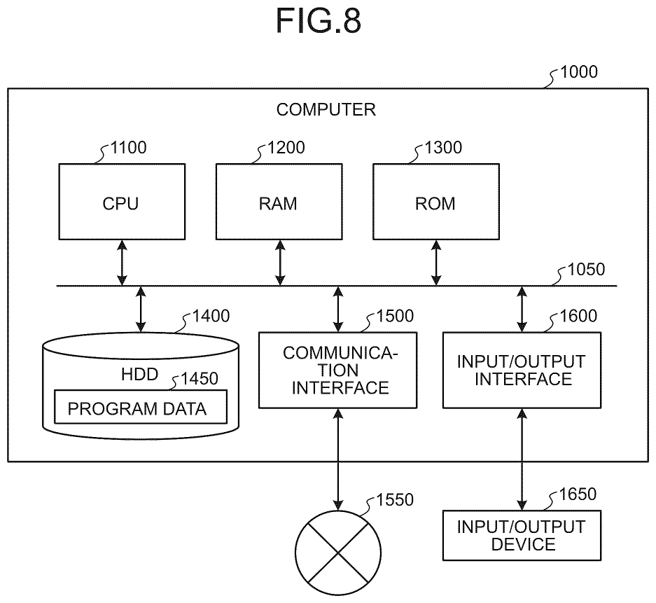

The information processing device 1 according to the embodiments described above is reproduced by a computer 1000 having a configuration as illustrated in FIG. 8, for example. FIG. 8 is a hardware configuration diagram illustrating an example of a computer that implements the functions of the information processing device according to the present disclosure. The computer 1000 includes a CPU 1100, a RAM 1200, a read only memory (ROM) 1300, a hard disk drive (HDD) 1400, a communication interface 1500, and an input/output interface 1600. The units of the computer 1000 are connected to one another by a bus 1050.

The CPU 1100 operates on the basis of a program stored in the ROM 1300 or the HDD 1400 to control the units. For example, the CPU 1100 expands a program stored in the ROM 1300 or the HDD 1400 into the RAM 1200, and executes processing corresponding to various programs.

The ROM 1300 stores a boot program such as a basic input output system (BIOS) executed by the CPU 1100 at the start of the computer 1000, a program that depends on the hardware of the computer 1000, and the like.

The HDD 1400 is a non-transitory computer-readable recording medium that non-transiently records a program executed by the CPU 1100, data used by the program, and the like. Specifically, the HDD 1400 is a non-transitory recording medium that records a program, which is an example of the program data 1450, according to the present disclosure.

The communication interface 1500 is an interface for the computer 1000 to connect to an external network 1550 (for example, the Internet). For example, the CPU 1100 receives data from another device or sends data generated by the CPU 1100 to another device via the communication interface 1500.

The input/output interface 1600 is an interface for connecting an input/output device 1650 to the computer 1000. For example, the CPU 1100 receives data from an input device such as a keyboard and a mouse via the input/output interface 1600. The CPU 1100 also sends data to an output device such as a display, a speaker, or a printer via the input/output interface 1600. Further, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing device 1 according to the embodiment, the CPU 1100 of the computer 1000 executes a program loaded onto the RAM 1200 to reproduce the function of the control unit 30 or the like. In addition, the HDD 1400 stores therein the program according to the present disclosure and various data. Note that the CPU 1100 reads the program data 1450 out of the HDD 1400 for execution; however, as another example, the programs may be acquired from another device via the external network 1550.

Although the embodiments of the present disclosure have been described above, the technical scope of the present disclosure is not limited to the embodiments described above as it is, and various modifications can be made without departing from the gist of the present disclosure. In addition, constituent elements of different embodiments and modifications may be appropriately combined.

Further, the effects of the embodiments described in the present specification are merely examples and are not limited, and other effects may be provided.

The present technology may also be configured as below.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising a model generation unit that generates a generative adversarial network including a discriminator and a generator, wherein
the model generation unit
separates the discriminator into a feature extraction network that generates, from data input to the discriminator, feature vectors of the data and a last layer in which the feature vectors distributed in a feature vector space are applied to a one-dimensional space, and trains each of the feature extraction network and the last layer, and thereby generates a metrizable discriminator that is a discriminator capable of evaluating a distance between a probability distribution of generated feature vectors that are feature vectors of generated data generated by the generator and a probability distribution of real feature vectors that are feature vectors of real data included in a data set for training.

2. The information processing device according to claim 1, wherein
a parameter of the last layer is a parameter related to a direction in which the probability distribution of the generated feature vectors and the probability distribution of the real feature vectors distributed in the feature vector space are separated, and
the model generation unit
generates the metrizable discriminator by training the last layer to take a value of a parameter corresponding to the direction in which a distance between the probability distribution of the generated feature vectors and the probability distribution of the real feature vectors is increased.

3. The information processing device according to claim 1, wherein
the model generation unit
generates the metrizable discriminator by training the feature extraction network so that if the probability distribution of the generated feature vectors is moved in a specific direction, the probability distribution of the generated feature vectors and the probability distribution of the real feature vectors overlap each other.

4. The information processing device according to claim 1, wherein
the model generation unit
generates the metrizable discriminator by training the feature extraction network such that the data and the feature vectors have a one-to-one correspondence.

5. The information processing device according to claim 1, wherein
the model generation unit
generates the metrizable discriminator by separating a loss function of the discriminator into a loss function of the feature extraction network and a loss function of the last layer to learn a value of a parameter of the feature extraction network and a value of a parameter of the last layer.

6. The information processing device according to claim 1, wherein
the model generation unit
uses the metrizable discriminator to generate the generator trained to reduce a distance between the probability distribution of the generated feature vectors and the probability distribution of the real feature vectors.

7. The information processing device according to claim 1, further comprising
a data generation unit that uses the generator generated by the model generation unit to generate the generated data from random vectors.

8. An information processing method, by a computer, comprising:
generating a generative adversarial network including a discriminator and a generator; and
separating, by the computer, the discriminator into a feature extraction network that generates, from data input to the discriminator, feature vectors of the data and a last layer in which the feature vectors distributed in a feature vector space are applied to a one-dimensional space, and training each of the feature extraction network and the last layer to thereby generate a metrizable discriminator that is a discriminator capable of evaluating a distance between a probability distribution of generated feature vectors that are feature vectors of generated data generated by the generator and a probability distribution of real feature vectors that are feature vectors of real data included in a data set for training.

9. A non-transitory computer-readable storage medium having stored therein a program for causing a computer to execute:
generating a generative adversarial network including a discriminator and a generator; and
separating the discriminator into a feature extraction network that generates, from data input to the discriminator, feature vectors of the data and a last layer in which the feature vectors distributed in a feature vector space are applied to a one-dimensional space, and training each of the feature extraction network and the last layer to thereby generate a metrizable discriminator that is a discriminator capable of evaluating a distance between a probability distribution of generated feature vectors that are feature vectors of generated data generated by the generator and a probability distribution of real feature vectors that are feature vectors of real data included in a data set for training.
